(19) United States
(12) Patent Application Publication
(10) Pub. No.: US 2013/0028678 A1
(43) Pub. Date: Jan. 31, 2013

(54) ADJUSTABLE DEPTH STOP MECHANISM

(71) Applicant: Klaus-Dieter Arich, Hunstetten-Beuerbach (DE)

(72) Inventor: Klaus-Dieter Arich, Hunstetten-Beuerbach (DE)

(73) Assignee: BLACK & DECKER INC., Newark, DE (US)

(21) Appl. No.: 13/551,900

(22) Filed: Jul. 18, 2012

(30) Foreign Application Priority Data
Jul. 26, 2011 (GB) 1112838.6

(51) Int. Cl. B23B 49/00

(52) U.S. Cl. 408/241 S

(57) ABSTRACT

An adjustable depth stop mechanism including a support element with a through hole for receiving an elongate depth stop element which is provided with a tooth arrangement at at least one surface portion. The tooth arrangement extends in longitudinal direction of the depth stop element and is fixed against displacement in longitudinal direction in a latch position by a latch device provided on the support element. The depth stop element can be moved out of the latch position by rotation about its longitudinal axis to a position in which it can be displaced in longitudinal direction with respect to the support element.

### CROSS-REFERENCE TO RELATED APPLICATIONS

This application claims priority, under 35 U.S.C. §119(a)-(d), to UK Patent Application No. GB 11 128 38.6 filed Jul. 26, 2011, the contents of which are incorporated herein by reference in its entirety.

### FIELD OF THE INVENTION

The invention relates to an adjustable depth stop mechanism, as often used as part of a handheld drill, of a handheld rotary hammer or the like or as part of an auxiliary handle for a handheld electric power tool. Such a depth stop mechanism comprises a support element with a through hole for receiving an elongate or rod-like depth stop element which in use is adjusted by the user so that its front end is rearwardly offset with respect to the tip of the tool bit by a distance corresponding to the depth of the hole to be produced in a workpiece, generally in a wall. Thereby further feeding of the drill bit beyond the desired depth of the hole is prevented by engagement of the depth stop element with the surface of the workpiece.

### BACKGROUND OF THE INVENTION

In a known adjustable depth stop mechanism (EP 0 132 593 A2) the elongate depth stop element which has a hexagonal cross-section, is inserted in a through hole having a corresponding cross-section and being provided in a portion of a side handle forming a support element. In a side portion the through hole is open so that the tooth arrangement provided on a lateral surface of the depth stop element and extending in longitudinal direction can be selectively brought into engagement with a latch element of a latch device which latch element comprises teeth corresponding to the teeth of the tooth arrangement. The latch element is held in engagement with the teeth of the tooth arrangement by spring force and the user can manually displace the latch element out of the latch position to be able to displace the depth stop element in longitudinal direction and to move it to a position for defining the depth of a hole to be produced.

Such a mechanism operates satisfactorily but requires that the user displaces the latch element against spring force with one hand and holds the latch element in such a release position to be able to displace the depth stop element with the other hand. Thus, such a mechanism required two-handed activation.

In another known adjustable depth stop mechanism (EP 0 261 386 B1) locking of the elongate depth stop element is effected by means of a locking element which comprises teeth and has the form of a locking plate which is pulled to the locking position by means of a screw. With this mechanism the user can release the locking element from the locking position by releasing the screw and can then displace the depth stop element to the desired position without having to hold simultaneously the locking element out of engagement. However, releasing of the locking element and moving back to the locking position requires rotation of the screw.

### BRIEF SUMMARY OF THE INVENTION

It is an object of the invention to provide a depth stop mechanism which permits the user to adjust the depth stop element to the desired position and to latch it in this position using one hand only and in a simple way.

This is achieved by means of an adjustable depth stop mechanism according to claim 1.

The mechanism according to the invention permits the user to adjust the elongate depth stop element simply by rotating it about its longitudinal axis to move it out of the latch position, i.e. to move the tooth arrangement of the depth stop element out of engagement with the latch element so that the depth stop element can be displaced in longitudinal direction to the desired position and can then be fixed by rotating it back to the latch position. Actuation of another element by the user is not required. The user can fully adjust the elongate depth stop element with one hand only.

Preferably, the through hole has a circular cross-section and the outer circumferential portions of the teeth of the at least one tooth arrangement and the circumferential portions of the depth stop element located opposite thereto are located on a circle having a diameter which is only slightly smaller than the diameter of the through hole. Thereby the outer circumferential portions of the depth stop element are closely enclosed by the through hole. Thus, in the release position the depth stop element is guided by the wall defining the through hole when the depth stop element is displaced in longitudinal direction, and upon rotation about its longitudinal axis it is supported in a stable manner. Guiding is particularly effective if the outer circumferential portions of the teeth are formed by at least half of the circumferential extension of the tooth crests, as this results in a line or surface contact in circumferential direction between the depth stop element and the wall defining the through hole.

To permit rotation of the depth stop element about its longitudinal axis selectively in one direction or the other to move it to its latch position or out of its latch position, the depth stop element may be provided with tooth arrangements at two diametrically opposite sides. Then one or the other tooth arrangement comes into latch engagement with the latch element or one of the tooth-free surface portions comes in a position adjacent to the latch element when the depth stop element is rotated about its longitudinal axis by about 90° in one direction or the other. Also, one of the tooth-free surfaces can display metric units whilst the other diametrically opposite tooth-free surface can display non-metric units. The user can freely change between types of unit displayed before him because the depth stop element can find its latch position whether rotated through 90° in one direction or the other.

The latch element may comprise a single projection or a plurality of projections which project radially inwardly from the wall defining the through hole. More preferably, the latch element is spring biased towards the latch position and, therefore, at least limitedly displaceable. Thereby engagement of the teeth of the depth stop element and the latch element in the latch position is ensured even if after a long period of use a certain wear of the teeth and/or the latch element should have occurred.

The overall design is simplified and rendered stable when the latch element comprises an elongate spring arm having one of its ends held in the support element and being provided at its other end with at least one latch projection for engagement with the tooth engagement. Such a latch element is easy to manufacture and can be mounted in the support element in a simple way. For this purpose the support element may comprise two spaced rib portions through which the through hole extends and between which the end of the latch element is provided which comprises the at least one latch projection. Thereby the latch element is protected by means of the rib portions and the risk of an inadvertent displacement of the latch element and, therefore, of the depth stop element is considerably reduced.

### BRIEF DESCRIPTION OF THE DRAWINGS

In the following the invention will be explained in more detail with respect to the drawings showing schematically an embodiment.

FIG. 1 shows in a partial perspective view a side handle comprising a depth stop mechanism according to the invention.

FIG. 2 shows in a schematic partial sectional view the depth stop element of the depth stop mechanism of FIG. 1 in the latch position.

FIG. 3 shows in a view corresponding to FIG. 2 the depth stop element rotated about its longitudinal axis with respect to the latch position according to FIG. 2.

FIG. 4 shows in a view corresponding to FIGS. 2 and 3 the depth stop element in its release position in which it can be displaced in longitudinal direction.

### DETAILED DESCRIPTION OF THE INVENTION

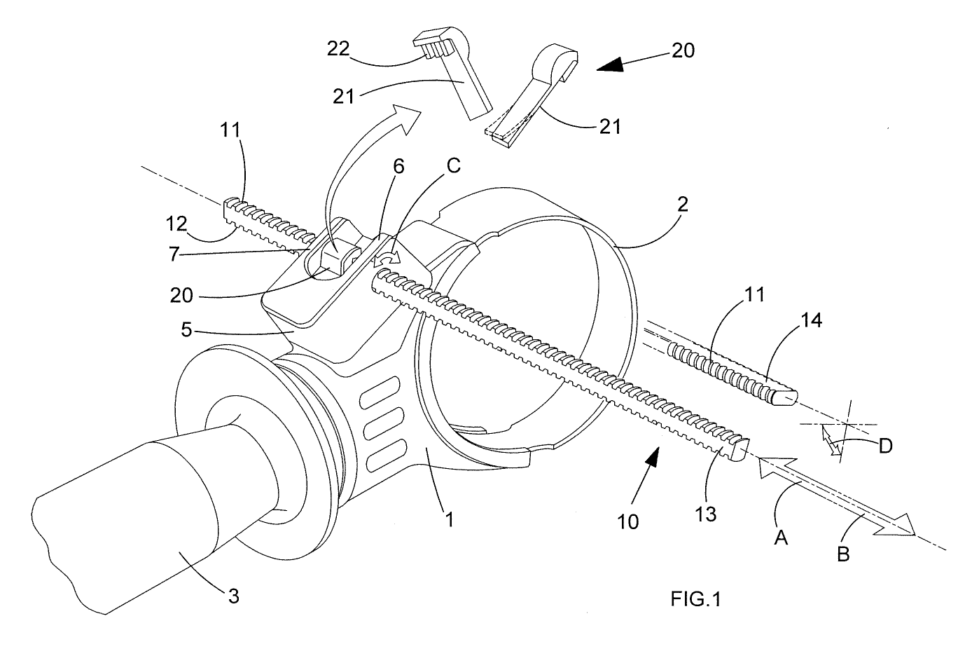

The side handle shown in FIG. 1 may be clamped to the neck of a handheld electrically powered drill (not shown). The side handle comprises a support element 1 on one side of which a handle element 3 is rotatably mounted, whereas the opposite side receives parts of a clamping strap 2 for enclosing the neck of the drill. This clamping strap is connected with the handle element 3 by means of a screw bolt (not shown), as described in EP 0 132 593 A2 so that rotation of the handle element 3 with respect to the support element 1 causes contracting or expanding of the clamping strap. The structure of the side handle is not part of the invention and will, therefore, not be described in detail.

A projection 5 is attached to the support element or is formed in one piece therewith. The projection comprises two rib portions 6, 7 through which a through hole 8 extends which has a circular cross-section. The middle axis of this through hole extends in parallel to the clamping surface formed by the clamping strap 2, i.e. the inner surface of the clamping strap, which in the assembled state is in clamping engagement with the neck of the drill.

An elongate or rod-like depth stop element 10 is inserted in the through hole 8. The depth stop element 10 comprises tooth arrangements or rack portions 11, 12 which are located at opposite surface portions and extend in longitudinal direction. The entire tooth crests of the teeth of these arrangements are curved in circumferential direction with a radius of curvature essentially the same as the radius of the through hole 8. The tooth crests which are located diametrically opposite, are arranged on a circle having a radius only slightly smaller than the radius of the through hole 8 so that the wall defining the through hole 8 forms a guide means for the depth stop element 10. The surface portions 13, 14 located in circumferential direction between the tooth arrangements 11, 12 are free of teeth and flattened but could also be curved with the same radius as the tooth crests.

A recess is provided between the rib portions 6 and 7 of the projection 5 in which recess a part of the depth stop element 10 is left uncovered and from which a receiving slot 9 continues into the projection 5. The lower surface of the slot 9 is located in a plane which contains the longitudinal axis of the through hole 8 and thus also the longitudinal axis of the inserted depth stop element 10. An elongate latch element 20 which is shown in two additional views in FIG. 1, comprises an elastically deformable arm 21 which is inserted in the slot 9 and held therein against displacement in longitudinal direction of the depth stop element 10. The latch element 20 further comprises a plurality of latch projections 22 at its end which extends in the recess between the rib portions 6 and 7 wherein the latch projections 22 face the depth stop element 10.

As shown in FIGS. 2 to 4, the outer end of the latch element 20 is always in engagement with the inserted depth stop element 10 so that the arm 21 of the latch element 20 which arm acts like a spring, is elastically deformed and thereby reliably held within the slot 9 of the projection 5. In the latch position, as indicated in FIG. 2, the latch projections 22 of the latch element 20 are in positive engagement with the teeth of one of the tooth arrangements 11, 12 of the depth stop element 10. Thereby the depth stop element 10 is held against displacement in axial or longitudinal direction in the through hole 8 of the projection 5.

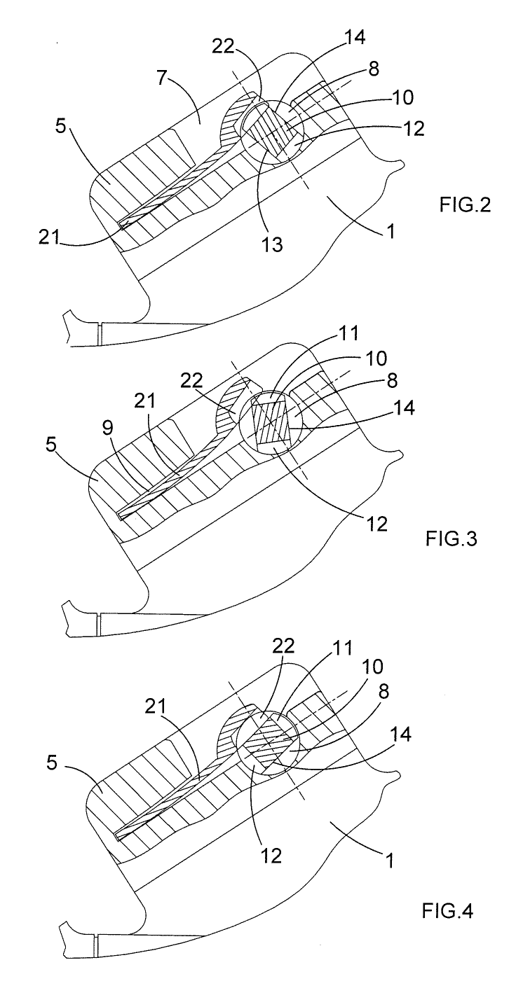

As the user manually rotates the depth stop element 10 about its longitudinal axis towards approximately 45°, i.e. in the direction of the Arrows C or D according to FIG. 1, then the depth stop element first moves towards an intermediate position (FIG. 3) in which deformation of the arm 21 of the latch element is increased to its maximum extent and resistance to rotational movement is at its peak. Continued rotation beyond 45° causes the depth stop element to pass this peak resistance point. This relaxes the arm 21 which biases continued rotation of the depth stop element towards an overall rotation of 90° at which stage the latch projections 22 are completely out of engagement with the teeth of the tooth arrangements and about one of the tooth-free surface portions 13, 14 of the depth stop element 10 (FIG. 4). During this procedure the user feels a tactile response from the depth stop element 10 as it passes the peak resistance point so that he instinctively knows that it has arrived at its release position.

In this release position the user can displace the depth stop element in the direction of Arrow A or Arrow B in FIG. 1 to position the front end of the depth stop element 10 to the desired distance from the tip of the drill bit inserted into the chuck of the drill and to thereby define the desired depth of the hole to be drilled.

Thereafter the user rotates the depth stop element 10 about its longitudinal axis by 90° in one direction or the other so that it is again moved to the latch position (FIG. 2) in which the latch projections 22 of the latch element 20 prevent axial displacement of the depth stop element 10 by engagement with the teeth of one of its tooth arrangements 13, 14. Again, the depth stop element 10 will pass another peak resistance point after approximately 45° rotation which provides another tactile response informing the user that the latch position is approaching.

1. An adjustable depth stop mechanism comprising:
an elongate depth stop element, having a tooth arrangement on at least one surface portion which tooth arrangement extends in longitudinal direction, whereas at least one surface portion adjacent to the tooth arrangement is free of teeth,
a support element with a through hole for receiving the depth stop element and
a latch device provided on the support element and including a latch element which in a latch position is in engagement with the at least one tooth arrangement to thereby prevent displacement of the depth stop element in longitudinal direction,
wherein the depth stop element can be rotated between a position in which the latch element is in said latch position, and a position in which the latch element engages with the at least one tooth-free surface portion of the depth stop element so that the depth stop element is displaceable in longitudinal direction with respect to the support element.

2. The adjustable depth stop mechanism of claim 1, wherein the through hole has a circular cross-section and that the outer circumferential portions of the teeth of the at least one tooth arrangement and the outer circumferential portions of the depth stop element located diametrically opposite to said teeth are located on a circle having a diameter which is only slightly smaller than the diameter of the through hole.

3. The adjustable depth stop mechanism of claim 2, wherein said outer circumferential portions of the teeth are formed at least by half of the circumferential extension of the tooth crests.

4. The adjustable depth stop mechanism of claim 1, wherein the depth stop element comprises two diametrically opposite tooth arrangements.

5. The adjustable depth stop mechanism of claim 1, wherein said latch element is loaded by spring force towards the latch position.

6. The adjustable depth stop mechanism of claim 5, wherein said latch element comprises an elongate spring arm which with one end is mounted in the support element, whereas its other end is provided with at least one latch projection for engagement with the at last one tooth arrangement.

7. The adjustable depth stop mechanism of claim 6, wherein said support element comprises two spaced rib portions through which the through hole extends and between which the end of the latch element is located which comprises at least one latch projection.

8. The adjustable depth stop mechanism of claim 1, wherein said support element is part of an auxiliary handle which can be releasably attached to a handheld power tool.

9. The adjustable depth stop mechanism of claim 1, wherein the adjustable depth stop mechanism is incorporated into a hand held power tool.
